(19) United States
(12) Patent Application Publication
(10) Pub. No.: US 2025/0357759 A1
(43) Pub. Date: Nov. 20, 2025

(54) POWER CONVERSION APPARATUS

(71) Applicant: FUJI ELECTRIC CO., LTD., Kawasaki-shi (JP)

(72) Inventor: Takashi HAYASHI, Tokyo (JP)

(73) Assignee: FUJI ELECTRIC CO., LTD., Kawasaki-shi (JP)

(21) Appl. No.: 19/284,448

(22) Filed: Jul. 29, 2025

Related U.S. Application Data
(63) Continuation of application No. PCT/JP2024/014832, filed on Apr. 12, 2024.

(30) Foreign Application Priority Data
May 23, 2023 (JP) 2023-084604

(51) Int. Cl. H02J 3/18; H02M 7/48

(52) U.S. Cl. CPC H02J 3/18; H02M 7/48

(57) ABSTRACT

A power conversion apparatus that is grid-connectable to a power system and has a virtual synchronous generator function. The power conversion apparatus includes a processor, and a non-transitory storage medium containing program instructions, execution of which by the processor causes the power conversion apparatus to provide functions of: a first output unit configured to measure active power and reactive power at a predetermined position of the power system when the power conversion apparatus is grid-connected to the power system, and output a difference between the active power at the predetermined position and a value corresponding to the reactive power at the predetermined position; and a generation unit configured to generate a phase of an output voltage of the power conversion apparatus, based on a command value of the active power, the difference, and the virtual synchronous generator function.

### CROSS-REFERENCE TO RELATED APPLICATIONS

This is a continuation application of International Patent Application No. PCT/JP2024/014832 filed Apr. 12, 2024, which claims the benefit of priority to Japanese Patent Application No. 2023-084604 filed May 23, 2023, the entire contents of each of which are hereby incorporated herein by reference.

### BACKGROUND

### Technical Field

The present disclosure relates to a power conversion apparatus.

### Description of the Related Art

In recent years, the proportion of power conversion apparatuses (inverters) has been increasing with an increase in renewable energy in power systems.

However, since the current-controlled inverters that are currently in widespread use do not have inertia, there is such a concern that a further increase in the proportion of the inverters will cause the frequency to be more likely to fluctuate, leading to the systems being unstable.

As a solution to this issue, it is expected to achieve practical use of inverters that perform Virtual Synchronous Generator (VSG) control so as to cause the inverters to behave like synchronous generators (Japanese Patent No. 7134388)

However, in the disclosure described in Japanese Patent No. 7134388, the resistance of the power transmission lines in the power system is regarded as being sufficiently small and negligible, and thus the resistance of the power transmission lines is not taken into account.

Therefore, if the resistance of the power transmission lines in the power system increases, the output voltage from the inverter may fluctuate significantly with respect to its target value to an unignorable degree.

The present disclosure is directed to provision of a power conversion apparatus that performs virtual synchronous generator control taking into account the resistance of a power transmission line.

### SUMMARY

An aspect of the present disclosure is a power conversion apparatus that is grid-connectable to a power system and has a virtual synchronous generator function, the power conversion apparatus comprising: a processor, and a non-transitory storage medium containing program instructions, execution of which by the processor causes the power conversion apparatus to provide functions of: a first output unit configured to measure active power and reactive power at a predetermined position of the power system when the power conversion apparatus is grid-connected to the power system, and output a difference between the active power at the predetermined position and a value corresponding to the reactive power at the predetermined position; and a generation unit configured to generate a phase of an output voltage of the power conversion apparatus, based on a command value of the active power, the difference, and the virtual synchronous generator function.

Another aspect of the present disclosure is a power conversion apparatus that is grid-connectable to a power system and has a virtual synchronous generator function, the power conversion apparatus comprising: a processor, and a non-transitory storage medium containing program instructions, execution of which by the processor causes the power conversion apparatus to provide functions of: a first output unit configured to measure active power and reactive power at a predetermined position of the power system when the power conversion apparatus is grid-connected to the power system, and measure active power and reactive power at a predetermined position of the power system when the power conversion apparatus is grid-connected to the power system, and output a first difference that is a difference between the active power at the predetermined position and a value corresponding to the reactive power at the predetermined position; a second output unit configured to output a second difference that is a difference between command value of the active power and a value corresponding to a command value of the reactive power; and a generation unit configured to generate a phase of an output voltage of the power conversion apparatus, based on the first difference, the second difference, and the virtual synchronous generator function.

Other features of the present disclosure will become apparent from the description of the present description.

According to the present disclosure, it is possible to provide a power conversion apparatus that performs virtual synchronous generator control taking into account the resistance of a transmission line.

### BRIEF DESCRIPTION OF DRAWINGS

FIG. 1 is a diagram illustrating an example of a power system 1 in which a power conversion apparatus 2 is provided.

FIG. 2 is a diagram illustrating functional blocks of a control device 20 according to a first embodiment.

FIG. 3 is a diagram illustrating an inverter output voltage phase generation unit 21 of a first embodiment.

FIG. 4 is a diagram illustrating a reactive power control unit 22 in a first embodiment.

FIGS. 5A to 5F are diagrams illustrating results of a numerical simulation.

FIGS. 6A to 6F are diagrams illustrating results of a numerical simulation.

FIGS. 7A to 7F are diagrams illustrating results of a numerical simulation.

FIG. 8 is a diagram illustrating functional blocks of a control device 50 according to a second embodiment.

FIG. 9 is a diagram illustrating an inverter output voltage phase generation unit 51 in a second embodiment.

FIG. 10 is a diagram illustrating a reactive power control unit 62 of a modification example.

### DETAILED DESCRIPTION

At least following matters will become apparent from the descriptions of the present description and the accompanying drawings.

Hereinafter, embodiments of the present disclosure will be described with reference to the drawings. The same or equivalent constituent elements, members, and the like illustrated in the drawings are given the same reference numerals, and repetitive description is omitted as appropriate.

### Embodiments

### <<Power Conversion Apparatus 2>>

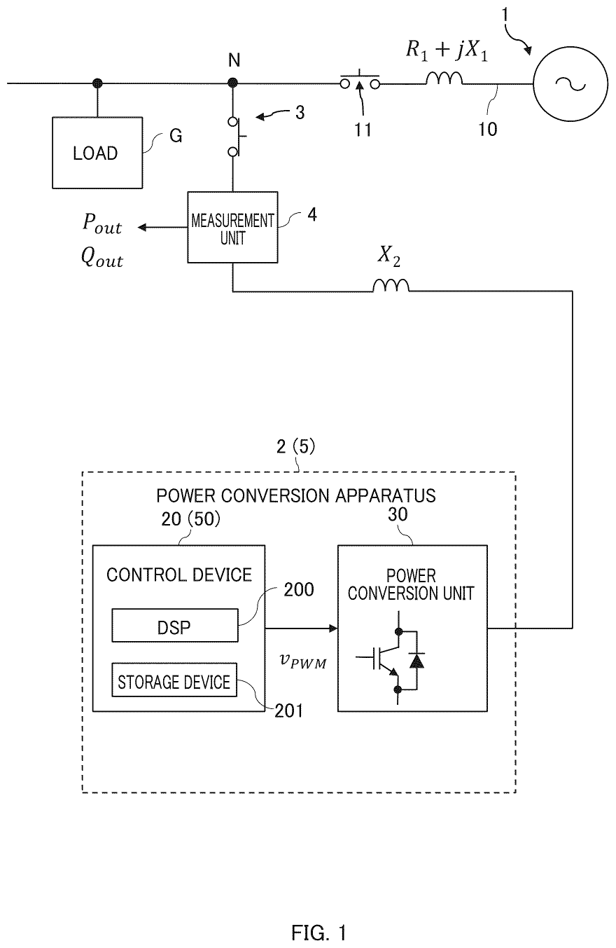

FIG. 1 is a diagram illustrating a power conversion apparatus 2 grid-connected to a power system 1. The power conversion apparatus 2 is an apparatus is grid-connectable to the power system 1, and has a virtual synchronous generator function.

During grid-connected, power is supplied, to a load G, both from the power system 1 through a power transmission line 10 having a resistance R₁ and a reactance X₁, and from the power conversion apparatus 2t. At the point of the installation of a circuit breaker 3, the power transmission line 10 and the power conversion apparatus 2 are connected. The load G is not necessarily provided.

A measurement unit 4 is installed between the circuit breaker 3 and the power conversion apparatus 2. The measurement unit 4 measures, at the point of the installation, active power Pₒᵤₜ, an output voltage vₒᵤₜ (instantaneous value), a frequency ωₒᵤₜ of the output voltage vₒᵤₜ, an amplitude Vₒᵤₜ of the output voltage, and the like, which are the outputs from the power conversion apparatus, and inputs results to the power conversion apparatus 2.

Alternatively, the measurement unit 4 measures the instantaneous voltage vₒᵤₜ and an instantaneous current iₒᵤₜ, and inputs results to the power conversion apparatus 2, and calculates the frequency ωₒᵤₜ, the active power Pₒᵤₜ, and a grid-connection point voltage amplitude Vₒᵤₜ.

It is assumed that the section between a point of grid-connection N and the point of the installation of the measurement unit 4 is sufficiently short, and thus the impedance of this section can be ignored. The measurement value measured by the measurement unit 4 is regarded as the measurement value at the point of grid-connection N.

It is assumed that the impedance (reactance) X₂ between the power conversion apparatus 2 and the circuit breaker 3 is sufficiently small.

### <Control Device 20>

The following describes, first, a hardware configuration of a control device 20, and then, the functional blocks of the control device 20.

### Hardware Configuration of Control Device 20

The control device 20 includes a Digital Signal Processor (DSP) 200 and a storage device 201 (FIG. 1).

### [DSP 200]

The DSP 200 executes a predetermined program stored in the storage device 201, to thereby implement various functions of the control device 20.

### [Storage Device 201]

The storage device 201 includes a non-transitory (e.g., non-volatile) storage device that stores various data to be executed or processed by the DSP 200.

The storage device 201 further has, for example, a Random-Access Memory (RAM) and the like (a memory 36a described later), and is used as a temporary storage area for various programs, data, and the like.

### Functional Blocks of Control Device 20

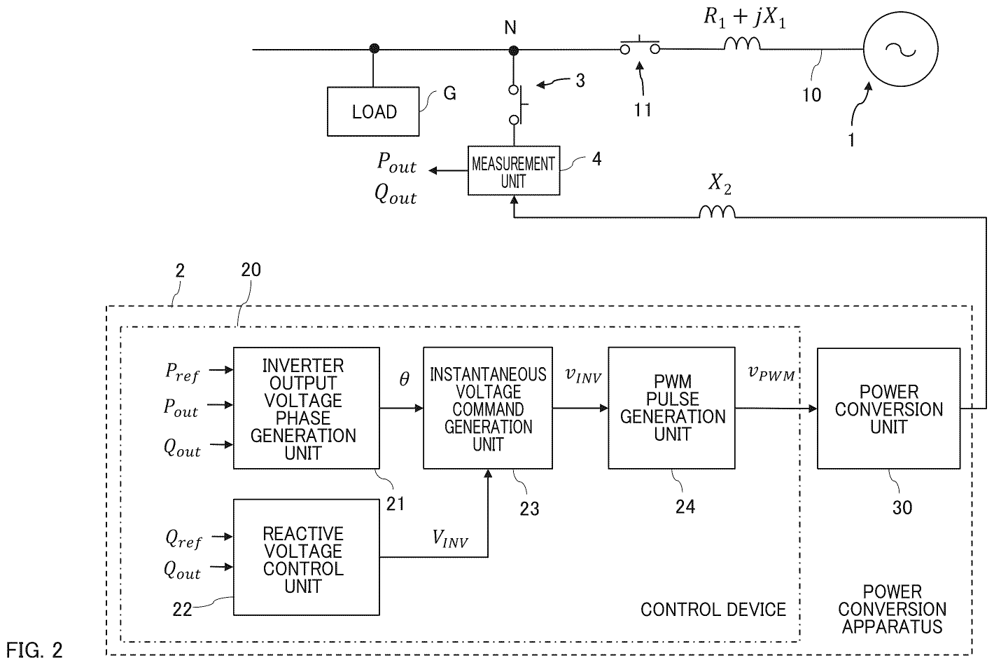

FIG. 2 is a diagram illustrating functional blocks of the control device 20. The control device 20 is a device that controls the voltage outputted by a power conversion unit 30, which will be described later in detail.

In the control device 20, an inverter output voltage phase generation unit 21, a reactive power control unit 22, an instantaneous voltage command generation unit 23, and a PWM pulse generation unit 24 are implemented.

### [Inverter Output Voltage Phase Generation Unit 21]

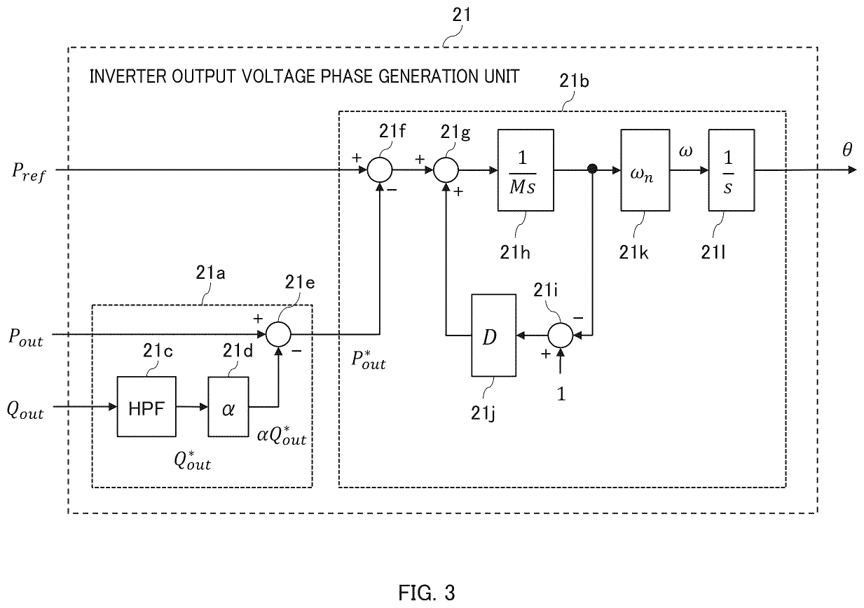

FIG. 3 is a diagram illustrating the inverter output voltage phase generation unit 21. The inverter output voltage phase generation unit 21 generates a phase θ of the output voltage of the power conversion unit 30, based on virtual synchronous generator control.

Specifically, the inverter output voltage phase generation unit 21 generates a VSG frequency, based on active power P_{ref} and the active power Pₒᵤₜ and reactive power Qₒᵤₜ, the active power P_{ref} being a target power outputted to the power system 1 by the power conversion apparatus 2, the active power Pₒᵤₜ and reactive power Qₒᵤₜ being actually outputted to the power system 1.

Then, the inverter output voltage phase generation unit 21 updates the VSG frequency, based on the VSG frequency, and generates the phase θ as its integral value.

Here, the target power P_{ref} is a value that is preset by a designer, operator, or the like of the power conversion apparatus 2. Further, the power Pₒᵤₜ is a value measured by the measurement unit 4 in the FIGS. 1 and 2.

In the following description, the inertia constant of the virtual synchronous generator implemented in the inverter output voltage phase generation unit 21 is given M, and the damping constant thereof is given D.

As illustrated in FIG. 3, the inverter output voltage phase generation unit 21 includes an output unit 21a and a generation unit 21b.

### Output Unit 21a

The output unit 21a (corresponding to a “first output unit”) outputs the difference Pₒᵤₜ* between the active power Pₒᵤₜ at the predetermined position of the power system 1 and a value corresponding to the reactive power Qₒᵤₜ at the predetermined position.

Here, the “predetermined position” refers to the point of the installation of the measurement unit 4 in an embodiment of the present disclosure. Further, although details will be described later, the “value according to the reactive power at the predetermined position” is a value obtained by multiplying, by a predetermined coefficient α, the component of the reactive power Qₒᵤₜ at the predetermined position greater than a predetermined frequency.

The output unit 21a includes a high-pass filter 21c, a multiplier 21d, and an adder 21e.

The high-pass filter 21c outputs Qₒᵤₜ* obtained by attenuating the components smaller than the predetermined frequency, with respect to the measurement value of the reactive power Qₒᵤₜ.

The multiplier 21d outputs, to the adder 21e, a value obtained by multiplying Qₒᵤₜ* inputted from the high-pass filter 21c by the coefficient α.

The above-described “predetermined coefficient α” is a value obtained by dividing the resistance R₁ of the power system 1 by the reactance X₁ of the power system 1, in an embodiment of the present disclosure.

$$α = \frac{{R}_{1}}{{X}_{1}} \qquad [ Math . 1 ]$$

The coefficient α is not limited thereto, and may be appropriately selected from within a range of values close thereto.

The adder 21e outputs, to the generation unit 21b, the difference Pₒᵤₜ* between the active power Pₒᵤₜ and the output (αQₒᵤₜ*) of the multiplier 21d.

Here, the difference Pₒᵤₜ* is given by the following expression.

$${P}_{out}^{*} = {P}_{out} - ( {R}_{1} / {X}_{1} ) {Q}_{out}^{*} \qquad [ Math . 2 ]$$

This expression uses the relationship in Expression 1.

### Generation Unit 21b

The generation unit 21b generates the phase of the output voltage of the power conversion apparatus 2, based on an active power command value P_{ref}, the difference Pₒᵤₜ*, and the virtual synchronous generator function.

The generation unit 21b includes adders 21f, 21g, 21i, multipliers 21j, 21k, and integrators 21h, 21l.

The adder 21f outputs, to the adder 21g, a value (P_{ref}−Pₒᵤₜ) obtained by subtracting the active power Pₒᵤₜ from the active power command value P_{ref}.

The adder 21g outputs, to the integrator 21h, a value obtained by adding the input from the multiplier 21j (described later) to the input value (P_{ref}−Pₒᵤₜ) inputted from the adder 21f.

The integrator 21h multiplies the input from the adder 21g by 1/M (i.e., divides it by M), and then outputs, to the multiplier 21k, the result of time integration from the time at which the initial value was given to the current time.

The value obtained by this integral calculation is a value obtained by unitizing the frequency ω outputted from the power conversion apparatus 2 using the nominal frequency on of the power system 1.

The nominal frequency on of the power system 1 is, for example, within Japan, a value obtained by multiplying 50 Hz by 2n, in eastern Japan, and is a value obtained by multiplying 60 Hz by 2n, in western Japan.

The adder 21i outputs, to the multiplier 21j, a value obtained by subtracting an input from the integrator 21h from 1. Here, the input to the adder 21i may be a value obtained by dividing a grid-connection point frequency ωₒᵤₜ measured by the measurement unit 4 by the nominal frequency ωₙ, instead of the input: from the integrator 21h.

The multiplier 21j outputs, to the adder 21g, a value obtained by multiplying the input from the adder 21i by the damping constant D of the VSG.

The multiplier 21k outputs a value obtained by multiplying the input from the integrator 21h by the nominal frequency on of the power system 1. The output value of the multiplier 21k is a frequency related to the output voltage of the power conversion apparatus 2 to the power system 1.

The integrator 21l integrates the input (frequency of the output voltage) from the multiplier 21k. By virtue of this calculation, the integrator 21l outputs the phase θ of the voltage to be outputted from the power conversion apparatus 2.

Note that in the inverter output voltage phase generation unit 21 of an embodiment of the present disclosure, the adder 21g, the integrator 21h, the adder 21i, the multiplier 21j, and the multiplier 21k correspond to a “second output unit”.

In other words, the “second output unit” outputs the frequency @ of the output voltage, based on the difference between the active power command value P_{ref} and the difference Pₒᵤₜ*, the inertia constant M in the virtual synchronous generator function, and the damping constant D in the virtual synchronous generator function. Further, the integrator 21l corresponds to a “third output unit”.

### [Reactive Power Control Unit 22]

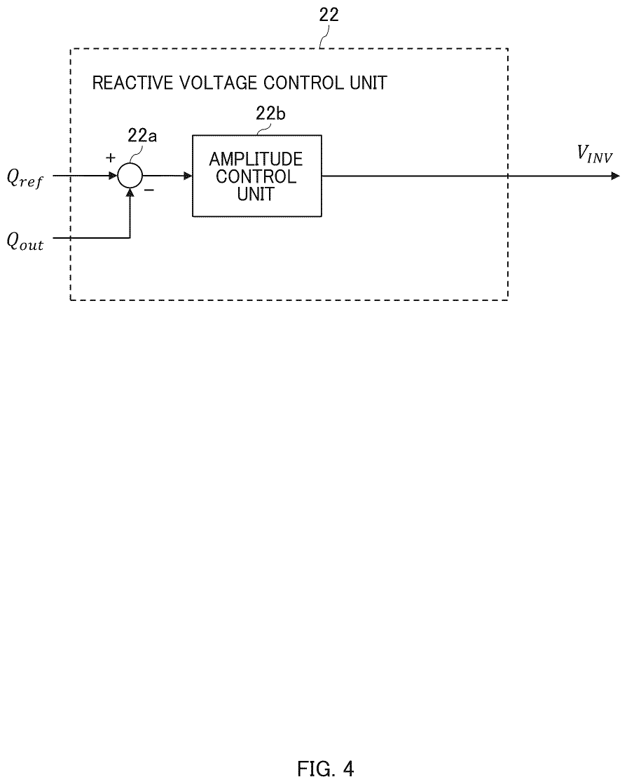

FIG. 4 is a diagram illustrating the reactive power control unit 22. The reactive power control unit 22 calculates an inverter output voltage amplitude command value V_{INV} (corresponding to an “output voltage amplitude command value”) to control the amplitude of the voltage outputted from the power conversion unit 30.

The reactive power control unit 22 outputs the inverter output voltage amplitude command value V_{INV}, based on a reactive power command value Q_{ref} and the reactive power measurement value Qₒᵤₜ. The inverter output voltage amplitude command value V_{INV} corresponds to the amplitude of the voltage actually outputted from the power conversion apparatus 2. The reactive power control unit 22 includes an adder 22a and an amplitude control unit 22b.

### Adder 22a

The adder 22a receives the reactive power command value Q_{ref} and the reactive power measurement value Qₒᵤₜ, and outputs the difference therebetween to the amplitude control unit 22b.

### Amplitude Control Unit 22b

The amplitude control unit 22b generates the inverter output voltage amplitude command value V_{INV}, based on the output of the adder 22a.

In this event, the amplitude control unit 22b generates the inverter voltage amplitude command value V_{INV} for causing the reactive power measurement value Qₒᵤₜ to be equal to the reactive power command value Q_{ref} in the point of the installation of the measurement unit 4.

### [Instantaneous Voltage Command Generation Unit 23]

Returning to FIG. 2, the instantaneous voltage command generation unit 23 generates an instantaneous voltage command value V_{INV} Of each of the three phases with respect to the voltage outputted from the power conversion apparatus 2.

### [PWM Pulse Generation Unit 24]

The PWM pulse generation unit 24 detects the point of intersection of a sine wave serving as a fundamental wave and a carrier wave implemented by a triangular wave, for example. By virtue of this, the PWM pulse generation unit 24 determines the duty ratio of a PWM pulse, to thereby generate a PWM pulse signal vPWM having the determined duty ratio.

The PWM pulse signal VPWM is outputted to the power conversion unit 30, and the inverter circuit of the power conversion unit 30 is driven.

### [Stabilization of Output Voltage]

According to the control device 20 of the power conversion apparatus 2 in an embodiment of the present disclosure, by virtue of having the above-described inverter output voltage phase generation unit 21, the resistance R₁ of the power transmission line 10 is taken into account, thereby being able to control the active power Pₒᵤₜ, reactive power Qₒᵤₜ, output voltage vₒᵤₜ, and the like with high precision. The following describes a reason for this.

The complex power, which is defined by the active power Pₒᵤₜ and by the reactive power Qₒᵤₜ, can be given by the following expression.

$${P}_{out} + {jQ}_{out} = {V}_{out} {e}^{j δ} \frac{{V}_{out} {e}^{- j δ} - {V}_{0}}{{R}_{1} - j {X}_{1}} \qquad [ Math . 3 ]$$

Here, vₒᵤₜ refers to the amplitude of the output voltage vₒᵤₜ of the power conversion apparatus 2, V0 refers to the amplitude of a voltage v₀ from the power system 1, and δ is the phase difference between the output voltage vₒᵤₜ and the system voltage v₀.

Here, such a case will be considered in which a minute variation Δδ in the phase difference δ and a minute variation ΔVₒᵤₜ in the amplitude Vₒᵤₜ occur from an equilibrium state. In this case, a variation Δθ in the inverter output voltage phase can be regarded as being equal to the variation Δδ in the phase difference, and thus, from Expression 3, a variation ΔPₒᵤₜ of the active power Pₒᵤₜ and a variation ΔQₒᵤₜ of the reactive power can be given by the following expression.

$$\begin{matrix}( \begin{matrix}Δ {P}_{out} \\ Δ {Q}_{out}\end{matrix} ) = \frac{{V}_{out} {V}_{0}}{{R}_{1}^{2} + {X}_{1}^{2}} ( \begin{matrix}{X}_{1} & {R}_{1} \\ - {R}_{1} & {X}_{1}\end{matrix} ) ( \begin{matrix}Δ θ \\ Δ {V}_{out} / {V}_{0}\end{matrix} ) \\ = \frac{{X}_{1} {V}_{out} {V}_{0}}{{R}_{1}^{2} + {X}_{1}^{2}} ( \begin{matrix}Δ θ + αΔ {V}_{out} / {V}_{0} \\ - α Δ θ + Δ {V}_{out} / {V}_{0}\end{matrix} )\end{matrix} \qquad [ Math . 4 ]$$

Here, the second-order or higher contributions of the variation Δθ and the variation ΔVₒᵤₜ are ignored.

Further, such a case will be considered in which the variation ΔPₒᵤₜ in the active power Pₒᵤₜ and the variation ΔQₒᵤₜ in the reactive power occur. In this case, from Expression 4, the variation Δθ and the variation ΔVₒᵤₜ can be given by the following Expression.

$$\begin{matrix}( \begin{matrix}Δ θ \\ Δ {V}_{out} / {V}_{0}\end{matrix} ) = \frac{1}{{V}_{out} {V}_{0}} ( \begin{matrix}{X}_{1} & - {R}_{1} \\ {R}_{1} & {X}_{1}\end{matrix} ) ( \begin{matrix}Δ {P}_{out} \\ Δ {Q}_{out}\end{matrix} ) \\ = \frac{{X}_{1}}{{V}_{out} {V}_{0}} ( \begin{matrix}Δ {P}_{out} - α Δ {Q}_{out} \\ α Δ {P}_{out} + Δ {Q}_{out}\end{matrix} )\end{matrix} \qquad [ Math . 5 ]$$

First, as can be seen from Expression 4, when the variation Δδ in the phase difference δ=Δθ occurs, not only the active power Pₒᵤₜ but also the reactive power Qₒᵤₜ may vary. This is because α (=R₁/X₁) can take a value other than 0 (zero), due to the influence of the resistance R₁ of the power transmission line 10.

Furthermore, as can be seen from Expression 5, when the variation ΔQₒᵤₜ in the reactive power occurs as well, not only in the active power Pₒᵤₜ, the variation Δδ in the phase difference δ=Δθ can occur. This is also because, α (=R₁/X₁) can take a value other than 0 (zero), due to the influence of the resistance R₁ of the power transmission line 10.

From the above, in controlling the phase θ of the output voltage vₒᵤₜ, it is needed to take into account the variation Δδ in the phase difference δ=Δθ caused by the variation ΔQₒᵤₜ in the reactive power.

Thus, in the inverter output voltage phase generation unit 21 of an embodiment of the present disclosure, not only the active power measurement value Pₒᵤₜ but also the reactive power measurement value Qₒᵤₜ is fed back, to generate the phase θ (FIG. 3).

As described above, the difference Pₒᵤₜ* given in Expression 2 is outputted from the output unit 21a. Here, the variation ΔPₒᵤₜ of the difference Pₒᵤₜ* is expressed by the following expression.

$$Δ {P}_{out}^{*} = Δ {P}_{out} - α Δ {Q}_{out}^{*} \qquad [ Math . 6 ]$$

Here, Expression 1 is used.

The variation ΔPₒᵤₜ* given in Expression 6 is a value proportional to the variation Δθ given in Expression 5 in the component Qₒᵤₜ* of the reactive power greater than the predetermined frequency.

According to the inverter output voltage phase generation unit 21 of an embodiment of the present disclosure, the difference Pₒᵤₜ* is controlled such that the active power command value P_{ref} is achieved. Accordingly, the variation ΔPₒᵤₜ* in the difference Pₒᵤₜ*, and hence the variation Δθ, is controlled so as to be suppressed to 0 (zero).

From the above, according to the power conversion apparatus 2 of an embodiment of the present disclosure, by virtue of including the above-described inverter output voltage phase generation unit 21, the resistance R₁ of the power transmission line 10 is taken into account, thereby being able to stably control the active power Pₒᵤₜ, reactive power Qₒᵤₜ, output voltage vₒᵤₜ, and the like.

### <Power Conversion Unit 30>

The power conversion unit 30 includes a direct-current (DC) power supply and an inverter circuit (not illustrated) including a plurality of switching devices. The inverter circuit converts the DC voltage from the DC power supply into an alternating-current (AC) voltage, and outputs a resultant voltage to the power system 1.

In this event, the inverter circuit outputs a voltage generated based on the PWM pulse signal vPWM, which is the output from the PWM pulse generation unit 24.

The phase θ in FIG. 3 is referred to also as “phase in the virtual synchronous generator function”, and the voltage amplitude command value V_{INV} in FIG. 4 is referred to also as “inverter output voltage amplitude command value in the virtual synchronous generator function”.

### <<Results of Numerical Simulations>>

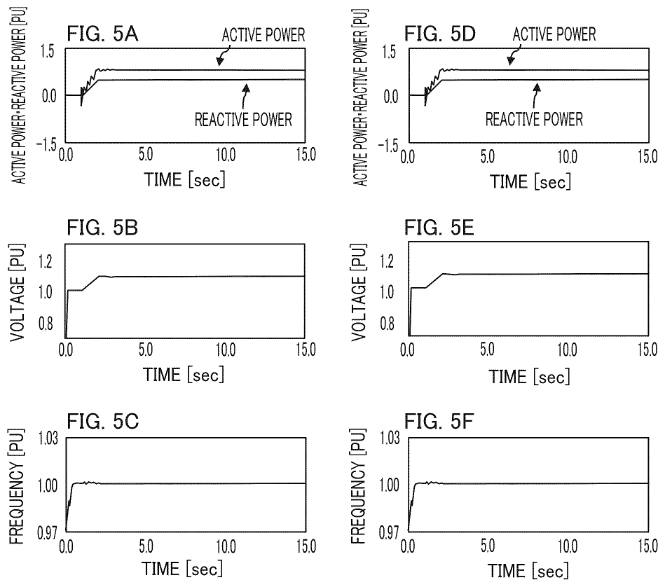

FIGS. 5 to 7 are diagrams illustrating results of numerical simulations. Each of FIGS. 5 to 7 compares the results of numerical simulations, assuming a conventional power conversion apparatus and the power conversion apparatus 2 of an embodiment of the present disclosure.

Each of the FIGS. 5A to 7F illustrates the result of a simulation in which only the resistance R₁ of the power transmission line 10 is varied. In the simulations illustrated in the diagrams, the reactance X₁ of the power transmission line 10 was set to 0.1 [pu]. Further, the active power command value P_{ref} was set to 0.8 [pu], and the reactive power command value Q_{ref} was set to 0.5 [pu].

FIGS. 5A to 5F illustrate the results when the resistance R₁ of the power transmission line 10 is 0.01 [pu]. FIGS. 5A to 5C illustrate the results assuming the conventional power conversion apparatus, and FIGS. 5D to 5F illustrate the results assuming the power conversion apparatus of an embodiment of the present disclosure.

In FIGS. 5A to 5F, FIGS. 5A and 5D indicate the active power and the reactive power, FIGS. 5B and 5E indicate the amplitude vₒᵤₜ of the output voltage, and FIGS. 5C and 5F indicate the frequency @ of the output voltage.

In the case of the resistance R₁ (0.01 [pu]) assumed in the simulation illustrated in FIGS. 5A to 5F, the results were almost the same between the conventional power conversion apparatus and the power conversion apparatus of an embodiment of the present disclosure. In other words, when the resistance R₁ is about 0.01 [pu], an issue will not arise, even if it is ignored.

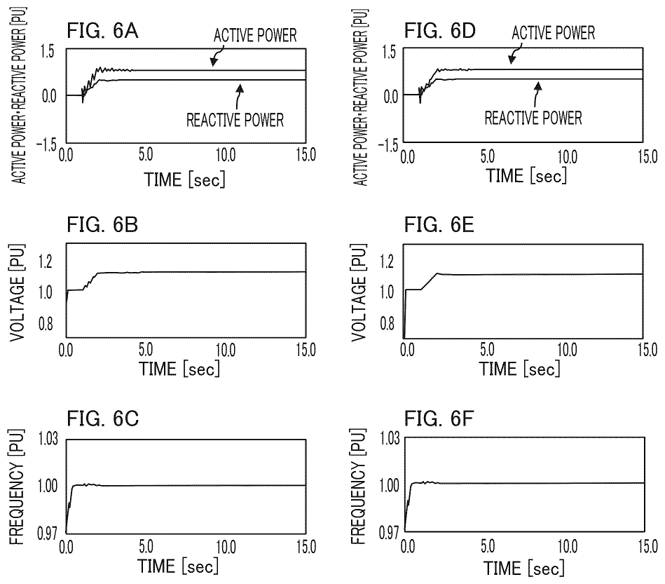

FIGS. 6A to 6F illustrate the results when the resistance of the power transmission line 10 is 0.05 [pu]. In other words, these results are obtained when assuming the resistance larger than that assumed in the simulation illustrated in FIGS. 5A to 5F. FIGS. 6A to 6F illustrate the results corresponding to those in FIGS. 5A to 5F.

According to the simulation results illustrated in FIGS. 6A to 6F, in the conventional power conversion apparatus, fluctuations occur in the active power Pₒᵤₜ at the time before 0.5 [sec]. Meanwhile, in the power conversion apparatus of an embodiment of the present disclosure, the fluctuations of the active power Pₒᵤₜ are weaker than those in the conventional apparatus.

With respect to those other than the active power Pₒᵤₜ, the results are substantially the same between the conventional apparatus and the apparatus of an embodiment of the present disclosure. In other words, when the resistance R₁ is αQₒᵤₜ 0.05 [pu] as well, an issue will not arise, even if it is ignored.

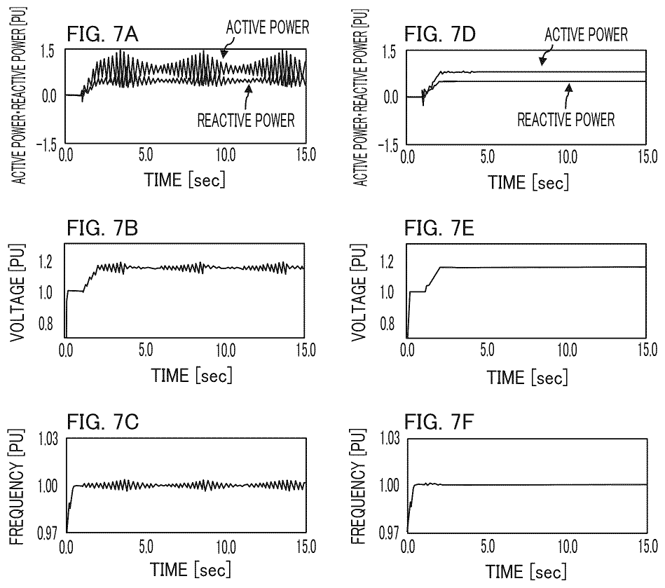

FIGS. 7A to 7F illustrate the results when the resistance of the power transmission line 10 is 0.1 [pu]. That is, these results are obtained when assuming the resistance larger than that assumed in the simulation illustrated in FIGS. 6A to 6F. FIGS. 7A to 7F illustrate the results corresponding to those in FIGS. 5A to 5F.

According to the simulation results illustrated in FIGS. 7A to 7F, in the conventional power conversion apparatus, significant fluctuations occurred in all of the amplitudes and phases of the active power, reactive power, and output voltages (FIGS. 7A to 7C). Accordingly, when the resistance of the power transmission line 10 is about 0.1 [pu], it cannot be ignored.

On the other hand, in the power conversion apparatus 2 of an embodiment of the present disclosure, fluctuations occurred in the active power, but they are weaker (FIGS. 7D to 7F) than those in the conventional apparatus. With respect to those other than the active power Pₒᵤₜ, significant fluctuations do not occur.

From the above results, according to the power conversion apparatus 2 of an embodiment of the present disclosure, the output from the power conversion apparatus 2 can be stably controlled, by virtue of taking into account the resistance of the power transmission line 10.

### Second Embodiment

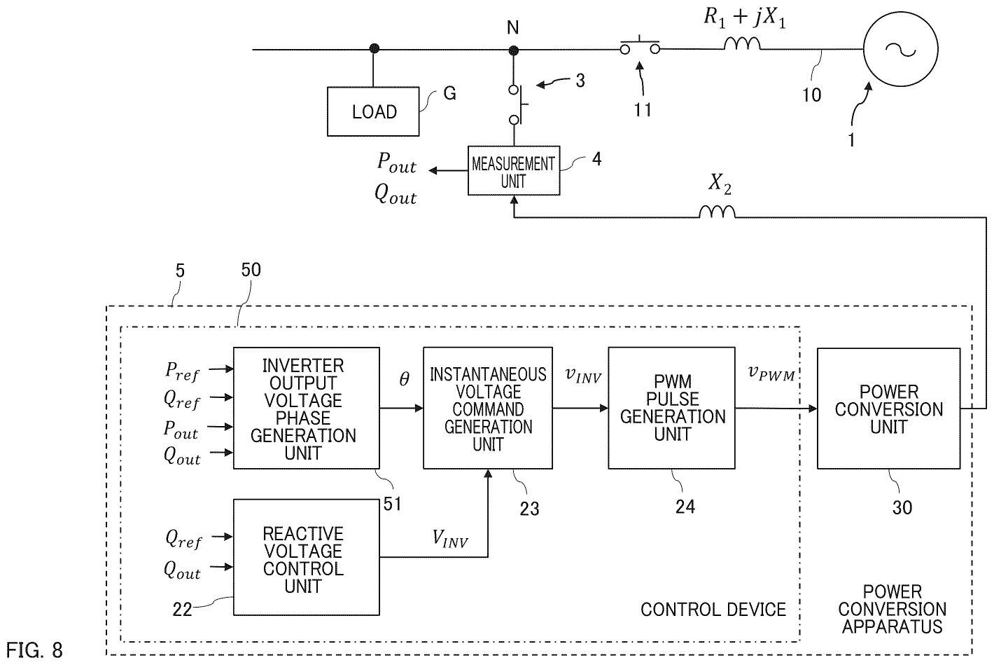

FIG. 8 is a diagram illustrating functional blocks of a control device 50 of a power conversion apparatus 5 according to an embodiment of the present disclosure. In the power conversion apparatus 5 of this embodiment of the present disclosure, the configuration of an inverter output voltage phase generation unit 51 is different, as compared to the first embodiment (FIG. 2).

### [Inverter Output Voltage Phase Generation Unit 51]

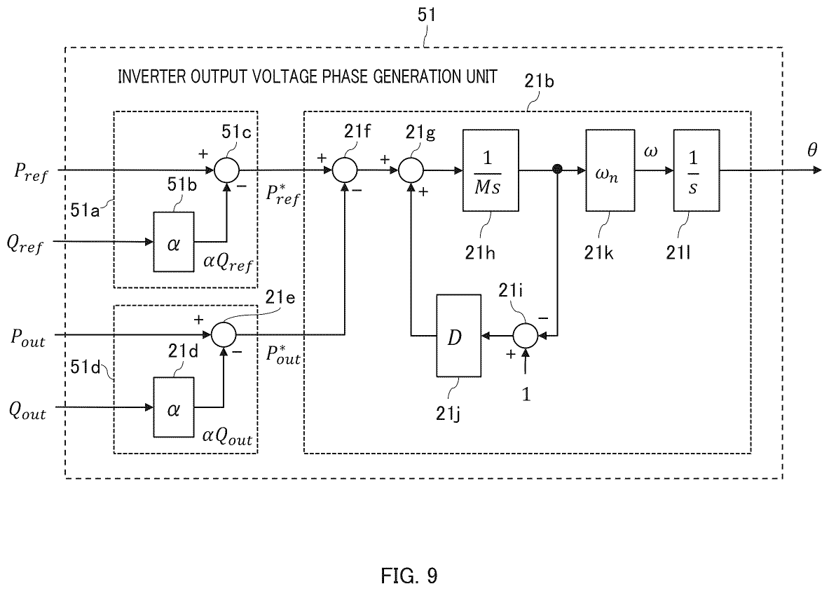

FIG. 9 is a diagram illustrating the inverter output voltage phase generation unit 51 in an embodiment of the present disclosure. The inverter output voltage phase generation unit 51 of this embodiment of the present disclosure includes an output unit 51a, an output unit 51d, and the generation unit 21b. Since the generation unit 21b is the same as in the first embodiment, the description thereof is omitted below.

### Output Unit 51a

The output unit 51a outputs a difference P_{ref}* (corresponding to a “second difference”) between the active power command value P_{ref} and a value corresponding to the reactive power command value Q_{ref}. The output unit 51a includes a multiplier 51b and an adder 51c.

The multiplier 51b outputs, to the adder 51c, a value obtained by multiplying the reactive power command value Q_{ref} by the coefficient α. In this embodiment of the present disclosure, the coefficient α is the same as in the first embodiment (Expression 1).

The adder 51c outputs, to the generation unit 21b, the difference P_{ref}* between the active power command value P_{ref} and the output (αQ_{ref}) of the multiplier 51b.

The output unit 51d outputs the difference Pₒᵤₜ* (corresponding to a “first difference”) between the active power Pₒᵤₜ at the predetermined position and the value corresponding to the reactive power Qₒᵤₜ at the predetermined position.

The output unit 51d includes the multiplier 21d and the adder 21e. The output unit 51d of an embodiment of the present disclosure corresponds to the output unit 21a (FIG. 3) of the first embodiment with the high-pass filter 21c omitted.

Accordingly, the adder 21e of the output unit 51d of an embodiment of the present disclosure outputs, to the generation unit 21b, the difference Pₒᵤₜ* between the active power measurement value Pₒᵤₜ and the output (αQₒᵤₜ) of the multiplier 51b.

Even in the configuration of the inverter output voltage phase generation unit 51 in this embodiment of the present disclosure, the difference Pₒᵤₜ* is controlled such that the active power command value P_{ref} is achieved. Accordingly, the variation ΔPₒᵤₜ*, and hence the variation Δθ according to Expression 5, is controlled so as to be suppressed to 0 (zero).

From the above, according to the power conversion apparatus 5 of an embodiment of the present disclosure, by virtue of having the above-described inverter output voltage phase generation unit 51, the resistance R₁ of the power transmission line 10 is taken into account, thereby being able to stably control the active power Pₒᵤₜ, reactive power Qₒᵤₜ, output voltage vₒᵤₜ, and the like.

Note that the output unit 51a of an embodiment of the present disclosure corresponds to the “first output unit”, and the output unit 51d of an embodiment of the present disclosure corresponds to the “second output unit”.

Note that in the inverter output voltage phase generation unit 51 of this embodiment of the present disclosure, the integrator 21h and the multiplier 21k correspond to the “third output unit”. Further, the integrator 21l corresponds to a “fourth output unit”.

### Modification Examples

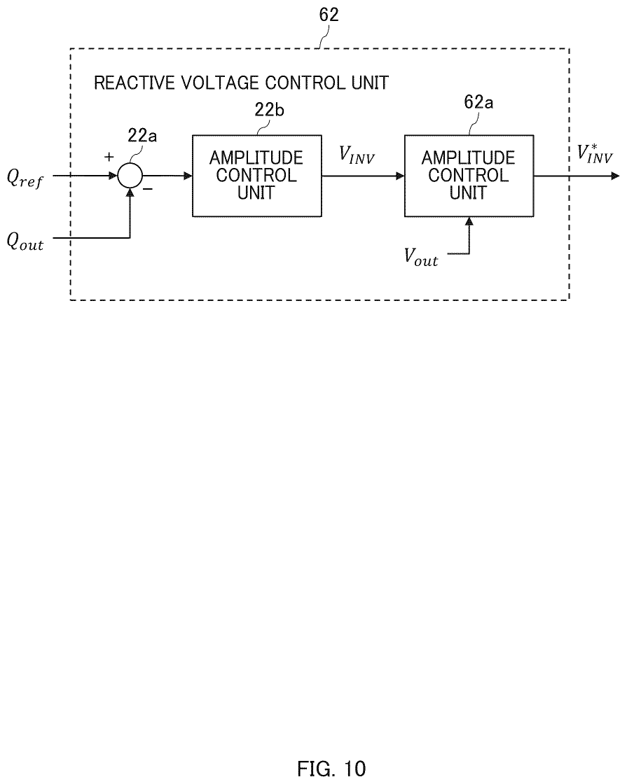

A power conversion apparatus of a modification example will be described. FIG. 10 is a diagram illustrating a reactive power control unit 62 of the modification example.

The reactive power control unit 62 of the modification example differs from the reactive power control unit 22 of an embodiment of the present disclosure in further including an amplitude control unit 62a.

The amplitude control unit 62a outputs a corrected inverter voltage amplitude command value V_{INV}* to the instantaneous voltage command generation unit 23, based on the inverter voltage amplitude command value V_{INV} inputted from the amplitude control generation unit 22b and the measurement value vₒᵤₜ of the amplitude of the output voltage.

The amplitude control unit 62a takes into account an impedance X₂ from the power conversion apparatus to the measurement unit 4, and generates and outputs the corrected inverter voltage amplitude command value V_{INV}* obtained by making correction such that the output voltage vₒᵤₜ will be equal to the inverter voltage amplitude command value V_{INV} in the point of the installation of the measurement unit 4.

### Summary

As described above, the power conversion apparatus 2 in the first embodiment is a power conversion apparatus that is connectable to the power system 1 and has a virtual synchronous generator function, the power conversion apparatus including the output unit 21a configured to measure the active power Pₒᵤₜ and the reactive power Qₒᵤₜ at the predetermined position during grid-connected, and output the difference Pₒᵤₜ* between the active power Pₒᵤₜ at the predetermined position of the power system 1 and the value corresponding to the reactive power Qₒᵤₜ at the predetermined position, and the generation unit 21b configured to generate the phase of the output voltage of the power conversion apparatus 2, based on the active power command value P_{ref}, the difference Pₒᵤₜ*, and the virtual synchronous generator function.

According to such a configuration, it is possible to control the active power and reactive power taking into account the resistance of the power transmission line 10. This makes it possible to suppress interference between the active power and the reactive power through the variations 40 in the phase of the output voltage. Accordingly, the output from the power conversion apparatus 2 can be stably controlled.

Further, in the power conversion apparatus 2, the value corresponding to the reactive power at the predetermined position is a value obtained by multiplying, by the predetermined coefficient, the component of the reactive power at the predetermined position greater than the predetermined frequency. According to such a configuration, it becomes possible to control the active power alone. Accordingly, the output from the power conversion apparatus 2 can be controlled further stably.

Further, in the power conversion apparatus 2, the generation unit 21b includes a second output unit configured to output the frequency of the output voltage, based on the difference between the active power command value P_{ref} and the difference Pₒᵤₜ*, the inertia constant in the virtual synchronous generator function, and the damping constant in the virtual synchronous generator function, and a third output unit configured to integrate the frequency of the output voltage, and output the phase. According to such a configuration, the output from the power conversion apparatus 2 can be controlled further stably.

Further, in the power conversion apparatus 2, the coefficient is the value obtained by dividing the resistance of the power system 1 by the reactance of the power system 1. According to such a configuration, it is possible to cancel out the linear contribution of the variation Δδ in the phase difference δ=Δθ.

Further, the reactive power control unit 22 is included, which is configured to generate the output voltage amplitude command value of the power conversion apparatus 2, based on the difference between the reactive power command value Q_{ref} and the reactive power Qₒᵤₜ at the predetermined position. According to such a configuration, the amplitude of the output voltage can be controlled with stability and high precision.

The power conversion apparatus 5 of the second embodiment is a power conversion apparatus that is grid-connectable to the power system 1 and has the virtual synchronous generator function, the power conversion apparatus including: the output unit 51d configured to measure the active power and the reactive power at the predetermined position during grid-connected, and measure the active power and the reactive power at the predetermined position during the grid-connected, and output the difference Pₒᵤₜ* between the active power Pₒᵤₜ at the predetermined position and a value corresponding to the reactive power Qₒᵤₜ at the predetermined position; the output unit 51a configured to output the difference P_{ref}* between the active power command value P_{ref} and a value corresponding to the reactive power command value Q_{ref}; and the generation unit 21b configured to generate the phase of the output voltage of the power conversion apparatus 5, based on the difference Pₒᵤₜ*, the second difference P_{ref}*, and the virtual synchronous generator function.

According to such a configuration, it is possible to control the active power and the reactive power taking into account the resistance of the power transmission line 10. This makes it possible to suppress interference between the active power and the reactive power through the variations 40 in the phase of the output voltage. Accordingly, the output from the power conversion apparatus 5 can be stably controlled.

Further, in the power conversion apparatus 5, the value corresponding to the reactive power at the predetermined position is the value obtained by multiplying the reactive power at the predetermined position by the predetermined coefficient, and the value corresponding to the command value of the reactive power is the value obtained by multiplying the command value of the reactive power by the coefficient. According to such a configuration, it becomes possible to control the active power alone. Accordingly, the output from the power conversion apparatus 5 can be controlled further stably.

Further, in the power conversion apparatus 5, the generation unit 21b includes the third output unit configured to output the frequency of the output voltage, based on the difference between the difference Pₒᵤₜ* and the difference P_{ref}*, the inertia constant in the virtual synchronous generator function, and the damping constant in the virtual synchronous generator function; and the fourth output unit configured to integrate the frequency of the output voltage, and output the phase. According to such a configuration, the output from the power conversion apparatus 5 can be controlled further stably.

Further, in the power conversion apparatus 5, the coefficient is the value obtained by dividing the resistance of the power system 1 by the reactance of the power system 1. According to such a configuration, it is possible to cancel out the linear contribution of the variation Δδ in the phase difference δ=Δθ.

Further, the power conversion apparatus 5 further includes the reactive power control unit 22 configured to generate the output voltage amplitude command value of the power conversion apparatus 5, based on the difference between the command value of the reactive power and the reactive power at the predetermined position. According to such a configuration, the amplitude of the output voltage can be controlled with stability and high precision.

Embodiments described above are presented as examples of the disclosure, and are not intended to limit the scope of the disclosure.

Configurations described above can be omitted, substituted, and/or altered in various ways without departing from the essential feature of the disclosure.

Embodiments and modifications thereof described above are included in the scope and the essential features of the disclosure as well as the disclosure described in the scope of the claims and equivalents thereof are included.

1. A power conversion apparatus that is grid-connectable to a power system and has a virtual synchronous generator function, the power conversion apparatus comprising:
a processor, and
a non-transitory storage medium containing program instructions, execution of which by the processor causes the power conversion apparatus to provide functions of:
a first output unit configured to measure active power and reactive power at a predetermined position of the power system when the power conversion apparatus is grid-connected to the power system, and output a difference between the active power at the predetermined position and a value corresponding to the reactive power at the predetermined position; and
a generation unit configured to generate a phase of an output voltage of the power conversion apparatus, based on a command value of the active power, the difference, and the virtual synchronous generator function.

2. The power conversion apparatus according to claim 1, wherein the value corresponding to the reactive power at the predetermined position is a value obtained by multiplying, by a predetermined coefficient, a component of the reactive power at the predetermined position greater than a predetermined frequency.

3. The power conversion apparatus according to claim 1, wherein
the virtual synchronous generator function of the power conversion apparatus has an inertia constant and a damping constant; and
the generation unit includes
a second output unit configured to output a frequency of the output voltage, based on the inertia constant, the damping constant, and a difference between the command value of the active power and the difference between the active power and the value corresponding to the reactive power at the predetermined position, and
a third output unit configured to integrate the frequency of the output voltage, and output the phase of the output voltage.

4. The power conversion apparatus according to claim 2, wherein the coefficient is a value obtained by dividing a resistance of the power system by a reactance of the power system.

5. The power conversion apparatus according to claim 1, further comprising:
a reactive power control unit configured to generate an output voltage amplitude command value of the power conversion apparatus, based on a difference between the command value of the reactive power and the reactive power at the predetermined position.

6. A power conversion apparatus that is grid-connectable to a power system and has a virtual synchronous generator function, the power conversion apparatus comprising:
a processor, and
a non-transitory storage medium containing program instructions, execution of which by the processor causes the power conversion apparatus to provide functions of:
a first output unit configured to measure active power and reactive power at a predetermined position of the power system when the power conversion apparatus is grid-connected to the power system, and measure active power and reactive power at a predetermined position of the power system when the power conversion apparatus is grid-connected to the power system, and output a first difference that is a difference between the active power at the predetermined position and a value corresponding to the reactive power at the predetermined position;
a second output unit configured to output a second difference that is a difference between a command value of the active power and a value corresponding to a command value of the reactive power; and
a generation unit configured to generate a phase of an output voltage of the power conversion apparatus, based on the first difference, the second difference, and the virtual synchronous generator function.

7. The power conversion apparatus according to claim 6, wherein
the value corresponding to the reactive power at the predetermined position is a value obtained by multiplying the reactive power at the predetermined position by a predetermined coefficient, and
the value corresponding to the command value of the reactive power is a value obtained by multiplying the command value of the reactive power by the coefficient.

8. The power conversion apparatus according to claim 6, wherein
the virtual synchronous generator function of the power conversion apparatus has an inertia constant and a damping constant; and
the generation unit includes
a third output unit configured to output a frequency of the output voltage, based on a difference between the first difference and the second difference, the inertia constant, and the damping constant, and
a fourth output unit configured to integrate the frequency of the output voltage, and output the phase of the output voltage.

9. The power conversion apparatus according to claim 7, wherein the coefficient is a value obtained by dividing a resistance of the power system by a reactance of the power system.

10. The power conversion apparatus according to claim 6, further comprising:
a reactive power control unit configured to generate an output voltage amplitude command value of the power conversion apparatus, based on a difference between the command value of the reactive power and the reactive power at the predetermined position.
